(19) United States
(12) Patent Application Publication
(10) Pub. No.: US 2026/0005948 A1
(43) Pub. Date: Jan. 1, 2026

(54) SYSTEM AND METHOD FOR IDENTIFYING APPLICATION VERSES NETWORK FACTORS DURING NETWORK PERFORMANCE MONITORING AND MANAGEMENT

(71) Applicant: CELONA, INC., Campbell, CA (US)

(72) Inventors: Preethi NATARAJAN, San Diego, CA (US); Sushanth CK, Campbell, CA (US); Mehmet YAVUZ, Campbell, CA (US); Srinivasan BALASUBRAMANIAN, San Diego, CA (US); Sourav BANDYOPADHYAY, Liluah Howrah (IN); Shashideep NUGGEHALLI, Campbell, CA (US)

(73) Assignee: CELONA, INC., Campbell, CA (US)

(21) Appl. No.: 19/322,554

(22) Filed: Sep. 8, 2025

Related U.S. Application Data
(63) Continuation-in-part of application No. 18/319,329, filed on May 17, 2023.
(63) Continuation-in-part of application No. 18/153,748, filed on Jan. 12, 2023, now abandoned.
(60) Provisional application No. 63/298,939, filed on Jan. 12, 2022.
(60) Provisional application No. 63/343,499, filed on May 18, 2022.

(51) Int. Cl. H04L 43/55

(52) U.S. Cl. CPC H04L 43/55

(57) ABSTRACT

A method and apparatus for identifying different factors as part of performance diagnostics are disclosed. The disclosed method and apparatus provide a downstream application for policy configuration and network performance diagnostics. Various embodiments of a method and apparatus for power management initiated from a Citizens Band radio Service Device (CBSD) are disclosed. In addition, methods and apparatus for extending concepts related to Self-Organizing Networks (SONs) to support Self-Organizing Neighborhoods (SONs) are also disclosed. Furthermore, various embodiments enable the management of frequency/channel/BW (BW) allocation, power allocation on each channel, and Physical Cell ID (PCI) selection.

### CLAIM OF PRIORITY TO PREVIOUSLY FILED PROVISIONAL APPLICATION—INCORPORATION BY REFERENCE

This non-provisional application is a continuation in-part of U.S. nonprovisional application Ser. No. 18/319,329 (ATTY DOCKET NO. CEL-073-PAP), filed May 17, 2023, claims, which claims priority to an earlier-filed provisional application No. 63/343,499 filed May 18, 2022, entitled “System and Method for Identifying Application Verses Network Factors During Network Performance Monitoring and Management” (ATTY DOCKET NO. CEL-073-PROV); this application is also a continuation-in-part of Ser. No. 18/153,748 (ATTY DOCKET NO. CEL-070-PAP), filed Jan. 12, 2023, which claims priority to provisional application No. 63/298,939, filed Jan. 12, 2022, entitled “Method and Apparatus for Neighbor Interference Management in a Self-Organizing Neighborhood” (ATTY DOCKET NO. CEL-070-PROV); all of the above applications and all of their contents, are hereby incorporated by reference herein, as if set forth herein in full.

### BACKGROUND

### (1) Technical Field

The disclosed method and apparatus relate generally to systems for wireless communication and networking. In particular, the disclosed method and apparatus relate to a method and apparatus for analyzing network performance and ensuring that policies regarding operational performance parameters are being met.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 shows the operation of a network when the throughput is below the configured GBR due to an application rate, which differs from the network performance issues.

FIG. 2 illustrates some of the solution components in accordance with some embodiments of the disclosed method and apparatus.

FIG. 3 illustrates the processing implemented by some embodiments of the disclosed method and apparatus.

FIG. 4 illustrates the environment of an application instance within the network.

FIG. 5 shows graphs of latent states that result from sample data.

FIG. 6 is an illustration of a binary classification scheme in accordance with some embodiments of the disclosed method and apparatus.

FIG. 7 is an illustration of the NL processing.

FIG. 8 is an illustration of a process for performing binary classification to determine whether there is a misconfigured policy.

FIG. 9 illustrates procedures for binary classification with application limited conditions.

FIG. 10 is an illustration of a multilabel hierarchical classification system for a particular set of performance factors.

FIG. 11 is an illustration of the classification and post-analysis process.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

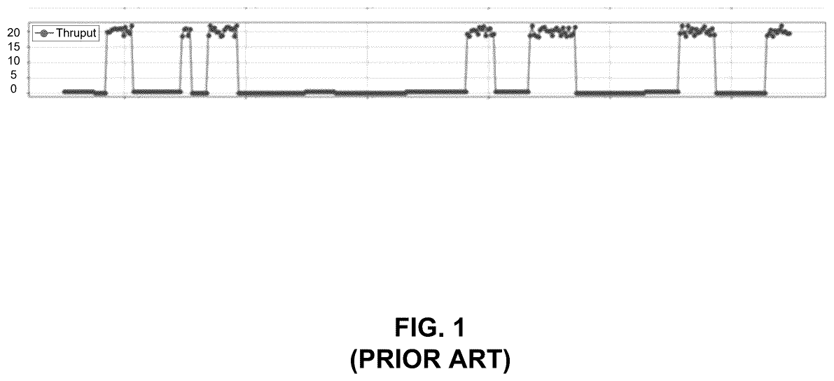

Private mobile networks provide service guarantees for applications. For example, Guaranteed Bit Rate (GBR) configuration in private mobile networks guarantees a specific bitrate to applications. There are several reasons why an observed service level can differ from a promised guarantee. FIG. 1 shows the operation of a network when the throughput is below the configured GBR due to an application rate, which differs from the network performance issues. For example, observed throughput could be below GBR due to effects shown in FIG. 1, including: network-limiting reasons, such as packet drops, scheduling issues, poor channel/radio quality, resource issues; and application-limiting reasons, such as when an application has silent periods or an application's required rate is lower than the configured policy. This can happen due to misconfiguration, or unknown/new/upgraded application behavior, etc. In addition, there may be factors external to the network under control, such as misconfigured device settings, backhaul/external network issues, etc.

It is of value to be able to distinguish between the different reasons so network operations can take relevant actions.

For example, network limitations are related to scheduling fixes, trigger resource optimizations, etc. Application limitations are related to the configuration (or reconfiguration) of QoS/service policy, exclusion from penalizing during SLA estimation, etc.

The disclosed method and apparatus identify the different factors as part of performance diagnostics. The disclosed method and apparatus also provide a downstream application for policy configuration and network performance diagnostics.

From a high-level perspective, the disclosed method and apparatus consist of the following steps:

In the first step: (i) learning latent state parameters and transitions for a filtered time series; (ii) model filtered time series (specific application traffic, “MicroSlice” traffic, dedicated bearer traffic etc.) as going through latent state transitions based on specific multivariate evidence/features (throughput, loss rate etc.); (iii) identify optimal latent state transitions via Hidden Markov Model or more generic Dynamic Bayesian Networks based models; and (iv) having each latent state map to specific parameters of observed evidence.

In the second step:

Associate semantics with latent state parameters and categorize the latent states into network-limited vs. not.

In the third step:

Classified states as input to other downstream analysis, including providing application to throughput policy configuration: identifying when to trigger changes to policy configuration, learn application characteristics and throughput configuration parameters, suggesting time periods of misconfigured policy to not include these periods in SLA estimation and providing application to network performance diagnostics, including identifying ongoing persistent network limiting conditions.

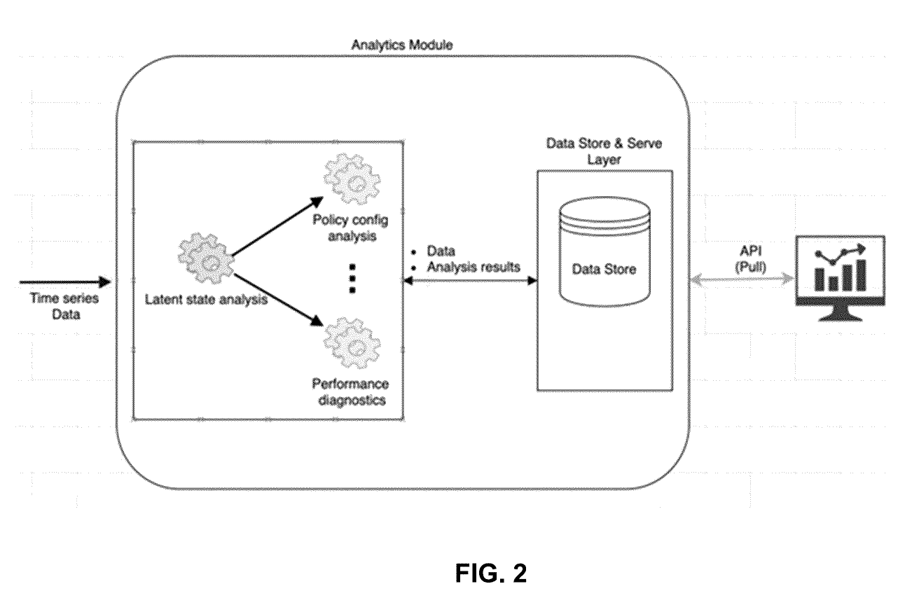

FIG. 2 illustrates some of the solution components in accordance with some embodiments of the disclosed method and apparatus.

In accordance with some embodiments, throughput diagnostics are provided for policy configuration. In some cases, it can be difficult to characterize new applications to configure throughput thresholds (e.g., GBR) or determine if the current policy configuration is still reflective of application needs. The following challenges make it hard to monitor exact application behavior: (i) all the observation points are usually within the network, making it infeasible to know exact application behavior; (ii) the application behavior could change dynamically. For example, characteristics and/or intermittent idle periods in the application sending rate may change. Network issues, in turn, can impact application behavior. For example, elastic applications adapt behavior (e.g., sending rate) based on observed network quality.

In some embodiments, preprocessing is performed to generate multivariate evidence time series combining features of interest: (i) for a given device and dedicated bearer; (ii) for application flow; (iii) for given access points (APs); and (iv) for given devices.

Regarding sampling frequency, smaller intervals (a few seconds) capture dynamics better than larger intervals.

Regarding duration and length in particular, in some embodiments, the last N hours of busy hour traffic are used to learn the most recent state transitions (since behavior can change over time). In some embodiments, only those devices with good signal quality (when applicable), such as devices with a CQI above 5. A CQI below 5 can be marked. In addition, feature values can be normalized via Min-Max scaling.

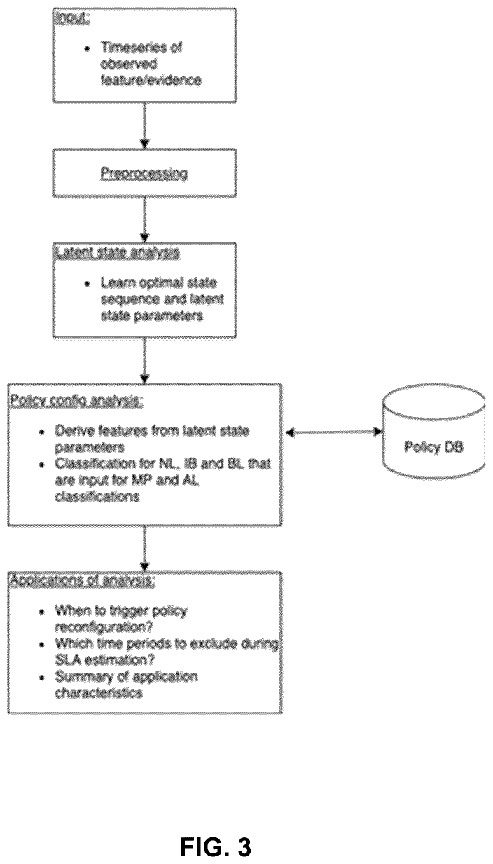

FIG. 3 illustrates the processing implemented by some embodiments of the disclosed method and apparatus.

It should be noted that the following challenges are present: (i) observation points are within the network, making it difficult to know exact application behavior; (iii) Dynamic application behavior, such as changing characteristic, and intermittent idle periods, etc. increase the challenge; (iv) network issues in turn impact application behavior, for example, applications adapt behavior (e.g., sending rate) rate based on observed network quality.

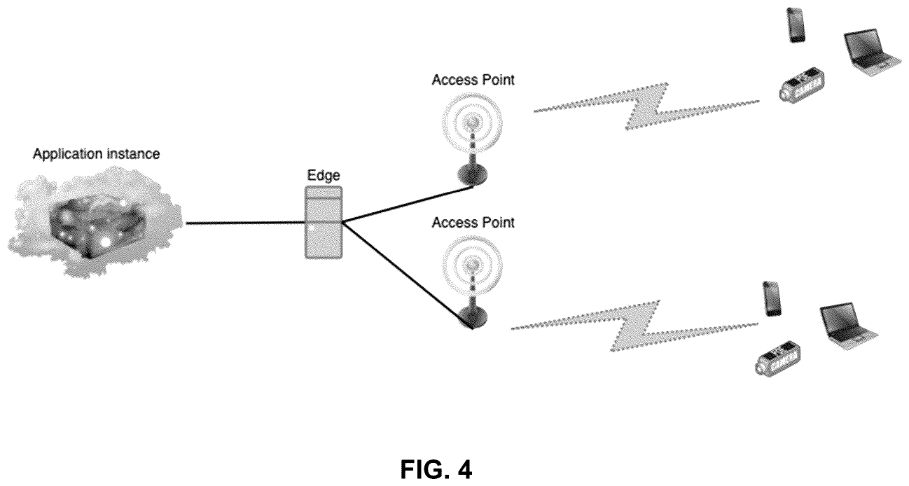

FIG. 4 illustrates the environment of an application instance within the network.

One or more of the following features are present in some embodiments of the disclosed method and apparatus: (i) network issues that impact application QoS are monitored by indicators monitored at the edge and RAN. These indicators are considered evidence that both incoming application characteristics and network quality need to be considered.

Features as evidence of incoming application characteristics include ingress buffer occupancy, packet arrival rate and packet sizes, inter packet distribution time as monitored at Edge/AP or inferred from periodic buffer status reports from the device. Features indicative of network quality including scheduling, resource issues, channel quality include: (i) throughput (bytes received/sent over time window) observed at edge/AP; (ii) capacity, PRB utilization; (iii) indicators of loss rate, delay, jitter as observed at edge/AP; (iv) NACK count at AP; (v) Block Error Rate (BLER) from AP; (vi) RLC retransmissions; and (vii) SINR/CQI per UE from AP.

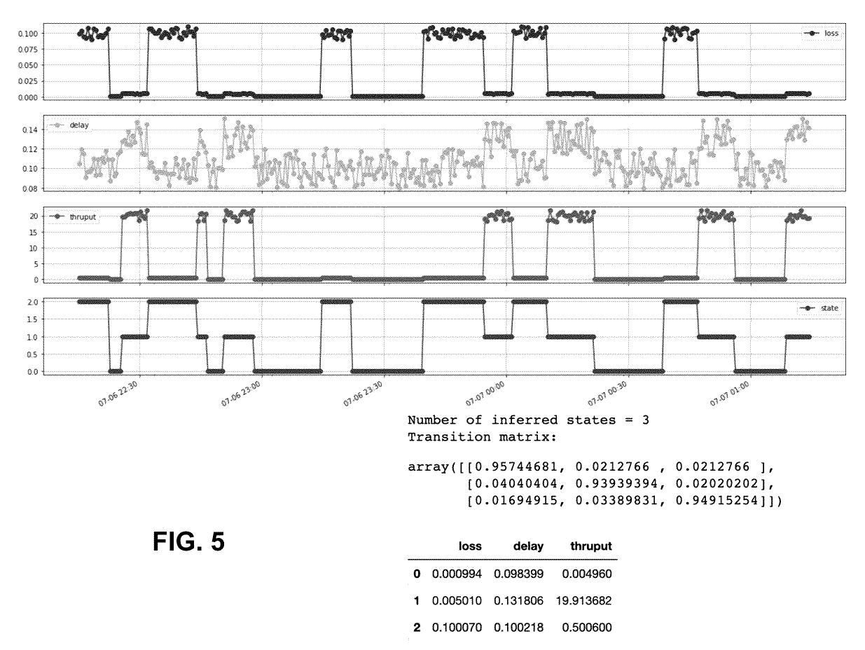

FIG. 5 shows graphs of latent states that result from sample data. State 0 is parameterized by low mean throughput and low loss rate, and so in some embodiments, may be application-limited. However, state 2 is parameterized by a high loss rate and low throughput, more likely to be network-limited.

### Binary Classification

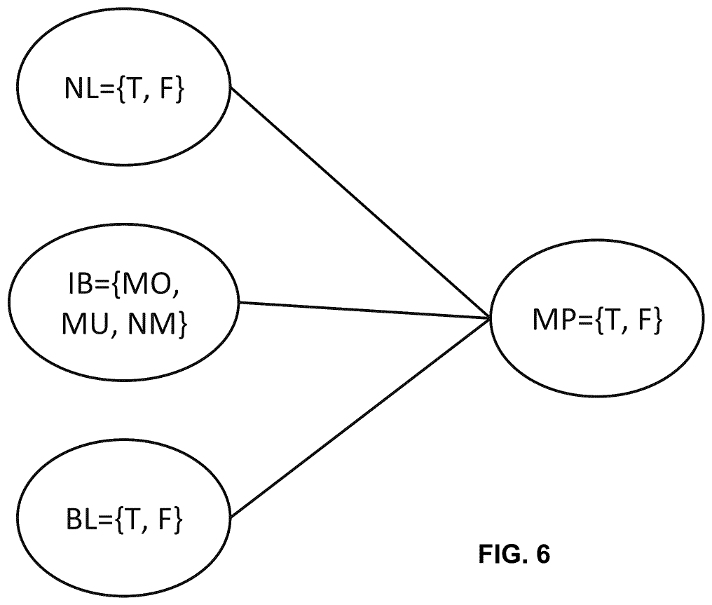

FIG. 6 is an illustration of a binary classification scheme in accordance with some embodiments of the disclosed method and apparatus. A determination can be made as to whether a policy misconfiguration (MP) is present as a function of logic states “T” and “F”, where T=a logical “true” state and “F”=a logical “false” state. Input features are output from 3 different classification models. The first is the Network Limited (NL)={T, F}, a probabilistic binary classification of whether the internal network state is network limited or not. The second is the Ingress Behavior (IB)={Misconfigured_Over (MO), Misconfigured_Under (MU), Not_Misconfigured (NM)}. Probabilistic classification of ingress traffic behavior, based on policy, is misconfigured and over the application rate, misconfigured and under the application rate or not misconfigured. The third is an External/backhaul limited (BL)={T, F}, probabilistic binary classification of whether/not traffic experienced external network issues.

### Network Limited Features

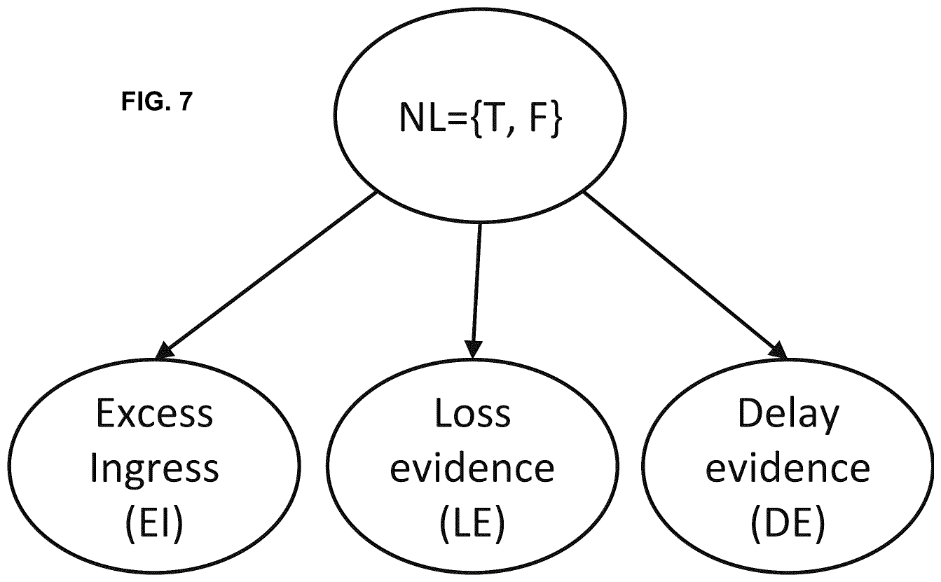

FIG. 7 is an illustration of the NL processing. Regarding the Network Limited input feature, Binary classification of NL={T, F} (network limited or not) based on learned latent state parameters. The features include: (i) Loss evidence (LE)=f(mean loss/drop/retransmission rate learned for this latent state); example f( )=max( ) (ii) Larger LE values increase probability of NL=T; (iii) Delay evidence, DE=f(delay samples in latent state); example f( )=InverseCDF(k); (iv) Larger DE values increase probability of NL=T; and (v) Excess Ingress (EI)=max(0, (mean ingress rate/mean observed throughput)−1).

Non-zero values of ingress are considered excessive when the ingress rate is higher than the observed throughput for the system. In some embodiments, caps are placed at zero when the ingress rate is below an observed throughput rate. It should be noted that there is a positive correlation between EI and prob for NL=T.

One example classification method is the well-known Naïve Bayes classifier, which assumes observed evidence is conditionally independent given NL. A Bayesian network is defined by a Joint distribution, P(NL, EI, LE, DE)=P(EI|NL)*P(LE|NL)*P(DE|NL)*P(NL). A Diagnostic inference is provided as P(NL|EI=ci, LE=le, DE=de).

### Ingress Behaviour Features

Ingress Behavior classes, IB={Not_Misconfigured (NM), Misconfigured_Over (MO), Misconfigured_Under (MU)}

Ingress rate ratio (IRR)=mean ingress rate/configured_threshold; Example of configured_threshold: GBR. The IRR denotes the normalized ingress rate. Decision boundaries derived from the IRR include: (i) Prob (IB=NM) maximum when the IRR is around 1; (ii) Prob (IB=MO) increases when configured throughput threshold is higher than ingress rate (i.e., as IRR decreases to 0); and (iii) Prob (IB=MU) increases when configured throughput threshold is lower than ingress rate (i.e., as IRR increases above 1).

### External Network (Including Backhaul) Limited

The binary classification for BL={T, F}. It should be noted that the quality of the external or backhaul connection impacts the application characteristics when the application is hosted externally to the network.

External Network Issues Observed for this Traffic

In some embodiments, the following features are observed: (i) explicit loss/delay measurements; (ii) network utilization; (iii) available bandwidth, (iv) etc. Each of these features can be derived from external monitoring or by monitoring TCP traffic streams. End-to-end application characteristics provided by application providers (i.e., applications hosted as a service, such as Zoom or Skype) are useful as inputs from which to derive these features as well. For example, when hosted service reports specific loss or delay, these features can be used to calculate BL loss evidence=diff (hosted service loss, internal network loss). Similarly, BL delay evidence=diff (hosted service delay, internal round-trip delay).

There is also a positive correlation between external/backhaul network issues and the probability for BL=T.

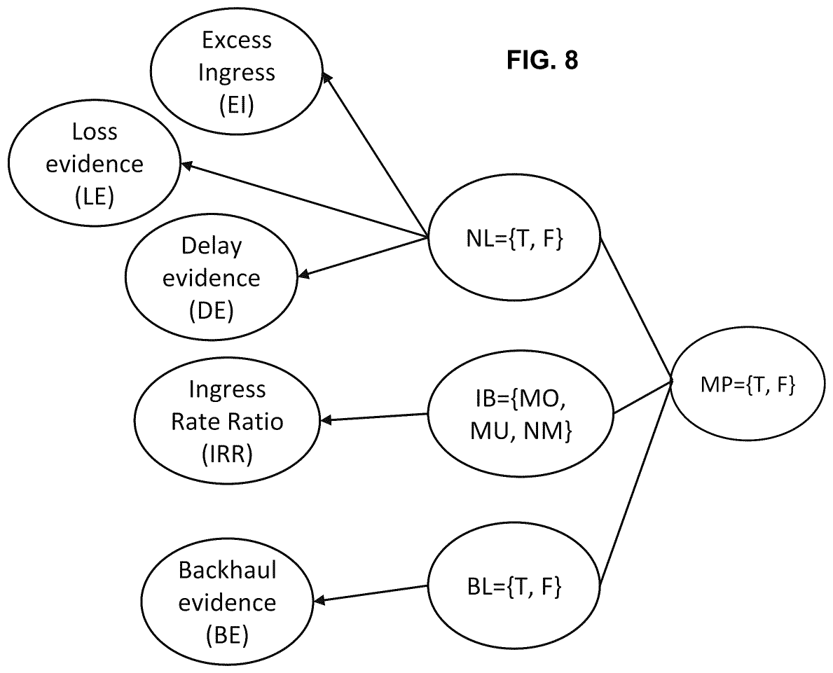

FIG. 8 is an illustration of a process for performing binary classification to determine whether there is a misconfigured policy. For the non-linear decision boundary for MP=T, the probability increases when:
(i) Prob (IB=MU) increases;
(ii) High prob (IB=MO);
(iii) High prob (NL=F); and
(iv) High prob (BL=F).

In some embodiments, policy reconfiguration is triggered upon sustained durations of MP=T, which denote a mismatch in the application ingress rate and the configured policy.

This impacts the SLA calculation in that the relatively high probability of MP=T states (i.e., policy misconfigured) and the corresponding time periods should be excluded while summarizing the SLA. Penalties, if any, are applicable only for durations of high probability for MP=F.

Various embodiments of a method and apparatus are disclosed that generate a time series of semantic network states from a time series of observed network metrics. The method and apparatus combine evidence from both Radio Access Network (RAN) and Edge metrics. The method and apparatus apply dynamic Bayesian network modeling (i.e., HMM) to learn latent state parameters and optimal latent state sequence. The method and apparatus also provide probabilistic classification of the latent state into a semantic network state using features derived from learned latent state parameters. The method and apparatus further provide metrics to quantify a network state's impact derived from state duration and transition probabilities.

Example applications of the above system for policy configuration diagnostics include: (i) feature identification for throughput policy diagnostics; and (ii) applications for when to trigger policy reconfiguration, relevancy for Service License Agreement (SLA) calculations, and policy configuration and reconfiguration parameter suggestions.

Examples of applications that apply to generic network performance diagnostics for connectivity, throughput, loss and delay issues include: (i) multilabel multiclass classification to identify factors correlating evidence across RAN and core; (ii) ability to account for unknown/unmonitored performance factors; and (iii) ability to incorporate evidence to diagnose device misconfiguration (i.e., APN) and external interference (i.e., unauthorized spectrum use).

### Binary Classification: Application Limited

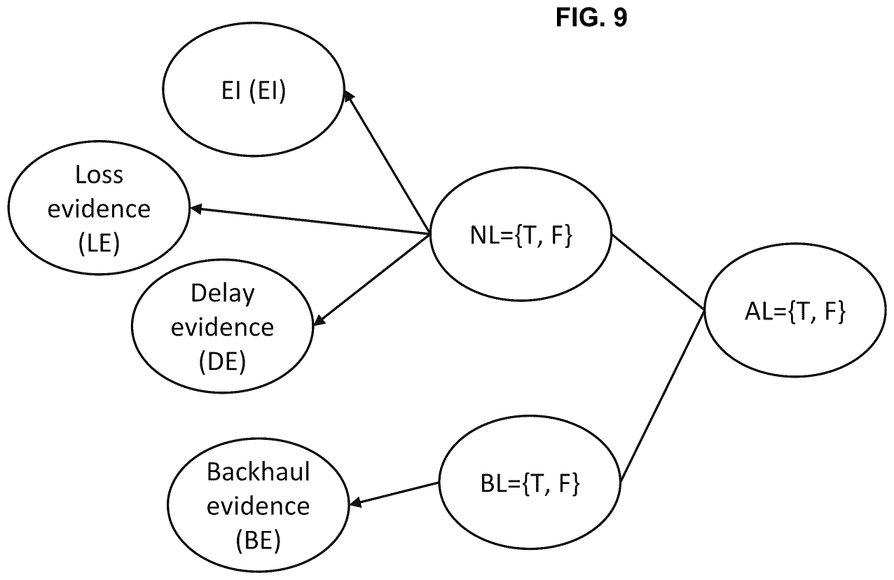

FIG. 9 illustrates procedures for binary classification with application to limited conditions. The following classification is used to identify “application limited” (AL) states that are indicative of application behaviors that are unaffected by other factors (such as network, backhaul). It can be seen that an AL=T state helps identify application characteristics for policy configuration parameter values. A decision boundary for AL=T is: High prob (NL=F) and high prob (BL=F).

### Learning Policy Config Parameters

The following are some of the learning policy configuration parameters that are useful in accordance with some embodiments of the disclosed method and apparatus: Durations of AL=T (for first-time config for a new application) or MP=T (for existing/configured application), which can be used to identify application characteristics, and suggest new or updated policy configuration parameters. Ingress rates during these states summarize an application's basic ingress rate characteristics. Analyzing latent state parameters during high probability for NL=T. This might include elastic versus inelastic application nature. For example, a determination may be made as to whether the ingress rate was impacted by the loss of evidence observed in this state. This can be inferred from the latent state's covariance matrix between ingress rate and loss/retransmission. Elastic applications typically exhibit a negative correlation between the latent state's LE and ingress rates. This can be used to learn an elastic application's incoming bitrate at different LE conditions.

### Network Performance Diagnostics—Features

In some embodiments, evidence obtained from observation of internal and external events and parameters is brought together (i.e., edge+RAN). In addition, in some embodiments, time series and categorical evidence are brought together. The NF=Edge is evidence observed at the edge. Prob (NF=Edge) increases with larger congestion drop rate, larger queueing delay, high edge cluster resource utilization and poor edge service health. Regarding NF=RAN, evidence is observed at the RAN, including Prob (NF=RAN) increases with larger loss/retransmissions, higher call drops, preemptions (congestion vs. interference), larger queueing/retransmission delays, poor AP resource health values and misconfiguration (for example, CA disabled).

Evidence is observed external to edge/RAN, such as monitoring whether Prob (NF=RAN) increases based on evidence of unauthorized use of CBRS spectrum in the same deployment location as available in an unauthorized spectrum use by location DB (e.g., derived from a combination of spectrum analyzer logs and spectrum grants from SAS).

In some embodiments, for NF=Backhaul: the Prob (NF=Backhaul) increases for evidence of backhaul issues.

In some embodiments, for NF=UE: evidence is observed about UE at the RAN/edge. The UE type/info is observed from headers (e.g., device fingerprinting), including UE capability information. In some embodiments, the UE details are gathered and stored in an inventory DB (e.g., during onboarding inventory). The Prob (NF=UE) is updated based on observed UE type.

### Multilabel Hierarchical Classification of Performance Factors

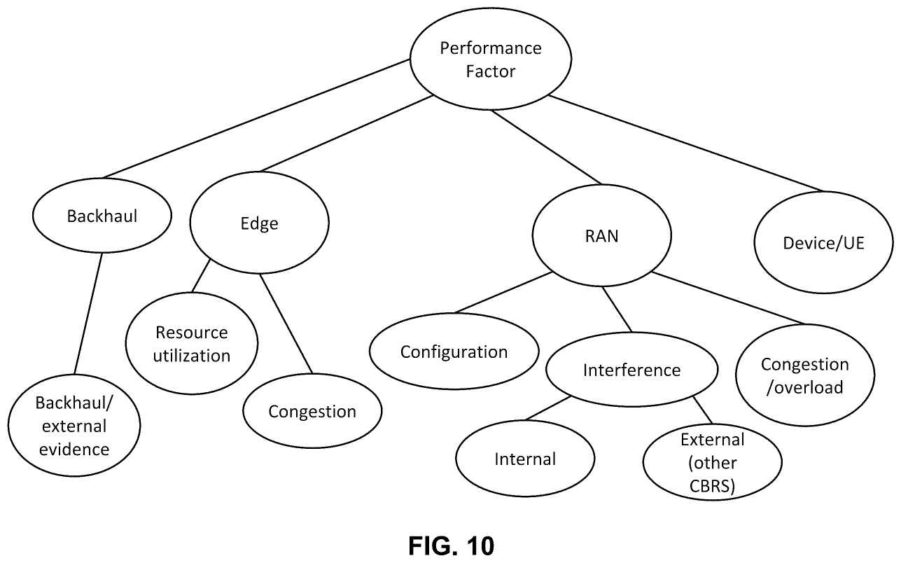

FIG. 10 is an illustration of a multilabel hierarchical classification system for a particular set of performance factors. In some embodiments, the following hierarchical multiclass classification of performance factors impacts traffic flow's performance: (i) local classifier per parent node or level; (ii) Multi-label classification to account for multiple factors active at the same time.

### Classification and Post Analysis

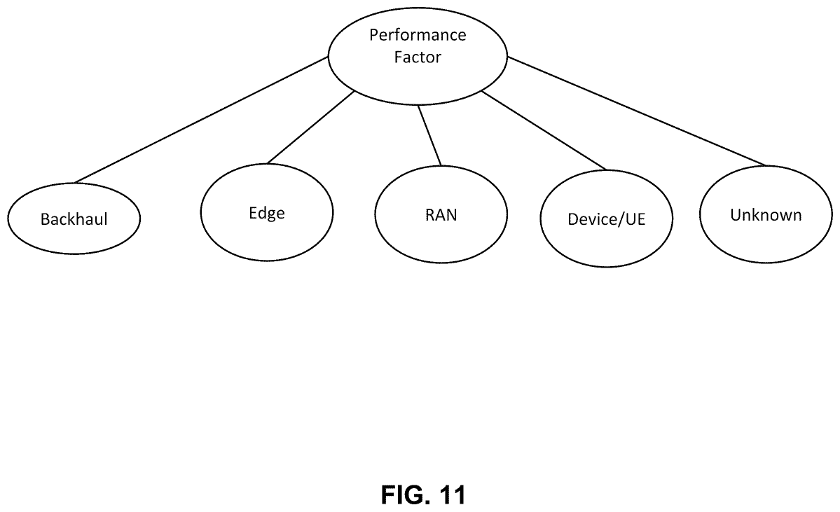

FIG. 11 is an illustration of the classification and post-analysis process. Input features for local classifiers are derived from learned latent state parameters (for time series evidence) and categorical evidence (for example, device type, configuration type). One or more performance factors (labels) that are active during the interval are identified; a NoisyOR Bayesian model accounts for unknown/unmonitored factors. The top factors impacting the system for a given time period are identified based on fractional duration and persistence of observed factors. Identified factors can be input for downstream troubleshooting recommendations, such as device configuration based on device type (e.g., APN configuration), channel reconfiguration based on interference from other CBRS deployments, etc.

It should be noted that the disclosed method and apparatus provide a system to generate a time series of semantic network states from a time series of observed network metrics, with the advantage of combining evidence from both RAN and Edge metrics. In addition, dynamic Bayesian network modeling (e.g., HMM) is applied to learn latent state parameters and the optimal latent state sequence. Probabilistic classification of the latent state is provided into a semantic network state using features derived from learned latent state parameters. Metrics are provided to quantify the network state's impact derived from state duration and transition probability. The following are example applications of the above framework for policy configuration diagnostics: (i) feature identification for throughput policy diagnostics; and (ii) applications for when to trigger policy reconfiguration, relevancy for SLA calculation, and policy (re) configuration parameters suggestion.

The following are examples of applications to generic network performance diagnostics for connectivity, throughput, loss and delay issues: (i) multilabel multiclass classification, including the ability to account for unknown/unmonitored performance factors; and (ii) identifying top factors within a specified time period used towards downstream troubleshooting analytics, including device configuration and interference from unauthorized CBRS use.

Although the disclosed method and apparatus are described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above-disclosed embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for performing network performance diagnostics, comprising:
a) learning latent state parameters and transitions for a filtered time series;
b) modeling a filtered time series as going through latent state transitions based on specific multivariate evidence/features;
c) identifying optimal transitions from one latent state to another latent state, where each latent state, maps to specific parameters of observed evidence;
d) associating semantics with latent state parameters;
e) categorizing the latent states into latent states that are network limited and network states that are not network limited;
f) classifying latent states as input to other downstream analysis, including providing application to throughput policy configuration:
g) identifying when to trigger changes to policy configuration,
h) learning application characteristics and throughput configuration parameters;
i) suggesting time periods of misconfigured policy; and
j) providing application to network performance diagnostics.
